(19) United States
(12) Patent Application Publication
(10) Pub. No.: US 2026/0080237 A1
(43) Pub. Date: Mar. 19, 2026

(54) Quadrature-Amplitude Modulation Optical Neural Network

(71) Applicant: Massachusetts Institute of Technology, Cambridge, MA (US)

(72) Inventors: Marc Bacvanski, Cambridge, MA (US); Sri Krishna Vadlamani, Cambridge, MA (US); Dirk Robert ENGLUND, Brookline, MA (US)

(73) Assignee: Massachusetts Institute of Technology, Cambridge, MA (US)

(21) Appl. No.: 19/330,898

(22) Filed: Sep. 17, 2025

Related U.S. Application Data
(60) Provisional application No. 63/695,572, filed on Sep. 17, 2024.

(51) Int. Cl. G06N 3/067

(52) U.S. Cl. CPC G06N 3/067

(57) ABSTRACT

Analog optical neural networks (ONNs) can reduce the energy of matrix-vector multiplication in neural network inference below that of digital electronics. However, realizing this promise remains challenging due to digital-to-analog (DAC) conversion—even at low bit precisions b, encoding 2^{b} levels of digital weights and inputs into the analog domain involves power-hungry electronics. Faced with similar challenges, telecommunications uses complex-valued Quadrature-Amplitude Modulation (QAM). QAM maximally exploits the complex amplitude to provide a quadratic 0(N²)→0(N) energy saving over intensity-only modulation. QAMNet, an ONN with lower energy consumption than existing ONNs, uses the complex nature of the amplitude of light with QAM. QAMNet accelerates complex-valued deep neural networks with accuracies indistinguishable from digital hardware. Compared to standard ONNs, QAMNet ONNs are (1) more accurate above moderate levels of total bit precision, (2) more accurate above low energy budgets, and (3) an optimal choice when hardware bit precision is limited.

### CROSS-REFERENCE TO RELATED APPLICATION(S)

This application claims the priority benefit, under 35 U.S.C. 119(e), of U.S. Application No. 63/695,572, filed on Sep. 17, 2024, which is incorporated by reference herein in its entirety for all purposes.

### BACKGROUND

Despite the recent successes and rapid adoption of deep neural networks (DNNs), their use for inference is limited by their high energy consumption. The power consumption of DNN inference is in large part due to the repeated multiply-accumulate (MAC) operations used to perform matrix-vector multiplication. Therefore, both specialized digital hardware, including application-specific integrated circuits (ASICs), field-programmable gate arrays (FPGAs), and graphics processing units (GPUs), as well as analog hardware have been developed to perform these operations faster and with lower energy.

### SUMMARY

QAMNet is a quadrature-amplitude modulation (QAM)-based optical neural network (ONN) that offers energy and accuracy advantages for DNN inference and other deep learning tasks. QAMNet uses in-phase/quadrature (I/Q) photoelectric multiplication photoelectric multiplication of complex-valued weights and inputs. QAMNet is amenable to implementation with standard telecommunications QAM modulators. Applied to deep learning inference tasks, QAMNet achieves accurate inference of pre-trained complex-valued neural networks even in the presence of realistic noise. Comparing QAMNet with I/Q photoelectric multipliers to real-valued neural networks with real-valued amplitude photoelectric multipliers shows that QAMNet (1) attains higher accuracy above moderate levels of total bit precision, (2) is more accurate above low energy budgets, and (3) is an optimal choice when hardware bit precision is limited.

QAMNet takes advantage of QAM originally developed for telecommunications. QAM is a discretized form of I/Q modulation, where each value (referred to as a symbol in QAM) is defined by a real (in-phase I) and imaginary (quadrature Q) component. A QAM modulator includes separate in-phase and quadrature modulators (e.g., separate Mach-Zehnder modulators driven by the in-phase and quadrature components, respectively). Together, these in-phase and quadrature modulators produce an output that can be expressed as a phasor on a carrier wave of frequency ω: s(t)=I cos(ωt)+Q sin(ωt) Due to the fixed precision of each modulator, a QAM-modulated signal takes on discrete points on the complex plane, which determines the QAM modulator's constellation diagram.

Compared to real amplitude modulation schemes, QAM uses quadratically less energy for the same number of symbols. To represent N unique symbols with QAM in the presence of noise Δ around each symbol takes only \sqrt{N} levels per axis (real and complex). Therefore, the total energy for both modulators is 2×[(\sqrt{N−1})Δ/2]², which is linear in N, in contrast to real-valued amplitude modulation, where the total energy scales as N².

QAMNet can be implemented with a first modulator, second modulator, beam splitters, and balanced photodetectors. In operation, the first modulator modulates real and imaginary components of a complex-valued input to a layer of the optical neural network onto in-phase and quadrature components, respectively, of a first optical carrier wave. Similarly, the second modulator modulates real and imaginary components of a complex-valued weight of the optical neural network onto in-phase and quadrature components, respectively, of a second optical carrier wave. The beam splitters, which are in optical communication with the first and second modulators, interfere the in-phase and quadrature components of the first and second optical carrier waves. The balanced photodetectors, which are in optical communication with the beam splitters, detect this interference.

QAMNet may also include capacitances, in electrical communication with the respective balanced photodetectors, that integrate photocurrents emitted by the balanced photodetectors. Other suitable components for QAMNet include first and second analog-to-digital converters (ADCs) in electrical communication with the balanced photodetectors. The first ADC digitizes a first photocurrent representing the interference of the in-phase components, and the second ADC digitizes a second photocurrent representing the interference of the quadrature components.

QAMNet can also be implemented with first and second QAM modulators, first and second beam splitters, and first and second balanced photodetectors. In operation, the first QAM modulator modulates real and imaginary components of a complex-valued input to a layer of the optical neural network onto in-phase and quadrature components, respectively, of a first optical carrier wave. Similarly, the second QAM modulator modulates real and imaginary components of a complex-valued weight of the optical neural network onto in-phase and quadrature components, respectively, of a second optical carrier wave. The first beam splitter, which is in optical communication with the first and second QAM modulators, interferes a first portion of the first optical carrier wave with a first portion of the second optical carrier wave. Likewise, the second beam splitter, which is also in optical communication with the first and second QAM modulators, interferes a second portion of the first optical carrier wave with a second portion of the second optical carrier wave. The first balanced photodetector, which is in optical communication with the first beam splitter, detects interference of the first portions of the first and second optical carrier waves. This interference represents a real component of a product of the complex-valued input and the complex-valued weight. And the second balanced photodetector, which is in optical communication with the second beam splitter, detects interference of the second portions of the first and second optical carrier waves. This interference represents an imaginary component of the product of the complex-valued input and the complex-valued weight.

The first QAM modulator may include an input beam splitter, phase shift, first and second amplitude modulators, and an output beam splitter. In operation, the input beam splitter splits the first optical carrier wave into an in-phase portion and a quadrature portion. The phase shift, which is in optical communication with a first output of the input beam splitter, shifts a phase of the quadrature portion of the first optical carrier wave with respect to a phase of the in-phase portion of the first optical carrier wave. The first amplitude modulator, which is in optical communication with the first output of the input beam splitter, modulates an amplitude of the quadrature portion of the first optical carrier wave with the real component of the complex-valued input. The second amplitude modulator, which is in optical communication with a second output of the input beam splitter, modulates an amplitude of the in-phase portion of the first optical carrier wave with the imaginary component of the complex-valued input. And the output beam splitter, which is in optical communication with the first and second amplitude modulators, combines the in-phase and quadrature portions of the first optical carrier wave.

QAMNet can also include a capacitance in electrical communication with the first balanced photodetector. This capacitance integrates a photocurrent emitted by the first balanced photodetector representing the real component of the product of the complex-valued input and the complex-valued weight. In some cases, an ADC in electrical communication with the capacitance generates a digital representation of the photocurrent integrated by the capacitance. An optional digital processor operably coupled to the ADC applies a nonlinearity to the digital representation.

Alternatively, QAMNet may include first and second QAM modulators and a QAM demodulator. In operation, the first QAM modulator modulates a first optical carrier wave with a QAM representation of an input to a layer of the optical neural network. Similarly, the second QAM modulator modulates a second optical carrier wave with a QAM representation of a weight of a layer of the optical neural network. And the QAM demodulator, which is optically coupled to the first and second QAM modulators, performs in-phase/quadrature (I/Q) photoelectric multiplication of the QAM representations of the input and the weight, either or both of which can be complex-valued.

The first QAM modulator may include first and second beam splitters, first and second amplitude modulators, and a phase shifter. The first beam splitter splits the first optical carrier wave into first and second portions and couples them to the first and second amplitude modulators, respectively. The first amplitude modulator modulates an amplitude of the first portion of the first optical carrier wave with an imaginary component of the input. The phase shifter, which is operably coupled to the second amplitude modulator's input, shifts a phase of the second portion with respect to a phase of the first portion. The second amplitude modulator modulates an amplitude of the second portion of the first optical carrier wave with a real component of the input. And the second beam splitter, which is operably coupled to the first and second amplitude modulators, combines the first and second portions of the first optical carrier wave.

The QAM demodulator can include first and second mixers coupled to first and second integrators, respectively. The first mixer mixes in-phase components of the first and second optical carrier waves. The second mixer mixes quadrature components of the first and second optical carrier waves. And the first and second integrator integrate the outputs of the first and second mixers, respectively, over time.

The first mixer may include a beam splitter and a balanced photodetector. The beam splitter combines the in-phase components of the first and second optical carrier waves, and the balanced photodetector generates a photocurrent representing an imaginary component of a product of the input and the weight. In these cases, the first integrator may comprise a capacitance coupled to an output of the balanced photodetector. QAMNet can also include an ADC, operably coupled to an output of the first integrator, to generate a digital representation of an output of the QAM demodulator and a digital processor, operably coupled to the ADC, to apply a nonlinearity to the digital representation.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a taxonomy of deep neural network (DNN) inference hardware.

FIG. 2 illustrates the algebra, circuit, and hardware of QAMNet, which is an optical neural network (ONN) hardware and architecture with lower energy consumption than existing ONNs thanks to its use of the complex nature of the amplitude of light with quadrature amplitude modulation (QAM).

FIG. 3 illustrates accuracy degradation across signal-to-noise ratios (SNRs) and QAM side (number of quantization levels per QAM axis) for the Deep Signal Network architecture. The outlined region indicates combinations with ≤5% drop in accuracy. The digitally trained accuracy was 68%.

FIG. 4A shows plots of accuracy comparisons between QAMNet and level equivalent 1D ONNs on the MNIST dataset with equivalence definitions given in TABLE 1.

FIG. 4B shows plots of accuracy comparisons between QAMNet and hardware equivalent 1D ONNs on the MNIST dataset with equivalence definitions given in TABLE 1.

FIG. 4C shows plots of accuracy comparisons between QAMNet and energy equivalent 1D ONNs on the MNIST dataset with equivalence definitions given in TABLE 1.

FIG. 5A is a close-up of the QAMNet inner product engine (I/Q photoelectric multiplier) shown in FIG. 2A.

FIG. 5B shows an amplitude-only photoelectric multiplier with four inner product engines.

FIG. 5C shows an amplitude-only photoelectric multiplier with two mixers.

FIG. 6 shows plots of accuracy comparisons for QAM ONNs versus level equivalent 1D ONNs, for different numbers of total levels (QAM constellation points). For an equivalent number of total levels, the QAM ONN uses quadratically less energy than the 1D ONN.

FIG. 7 shows plots of accuracy comparisons for QAM ONNs versus hardware equivalent 1D ONNs that have the same bit precision per modulator. Given amplitude modulators of limited bit precision, the QAM ONN enables higher accuracy using two of them in parallel for I/Q modulation.

FIG. 8 shows plots of accuracy comparisons for QAM ONNs versus energy equivalent 1D ONNs that have the same total inference energy, accounting for input activation energy. At moderate energy budgets and above, QAM ONNs achieve higher accuracy.

### DETAILED DESCRIPTION

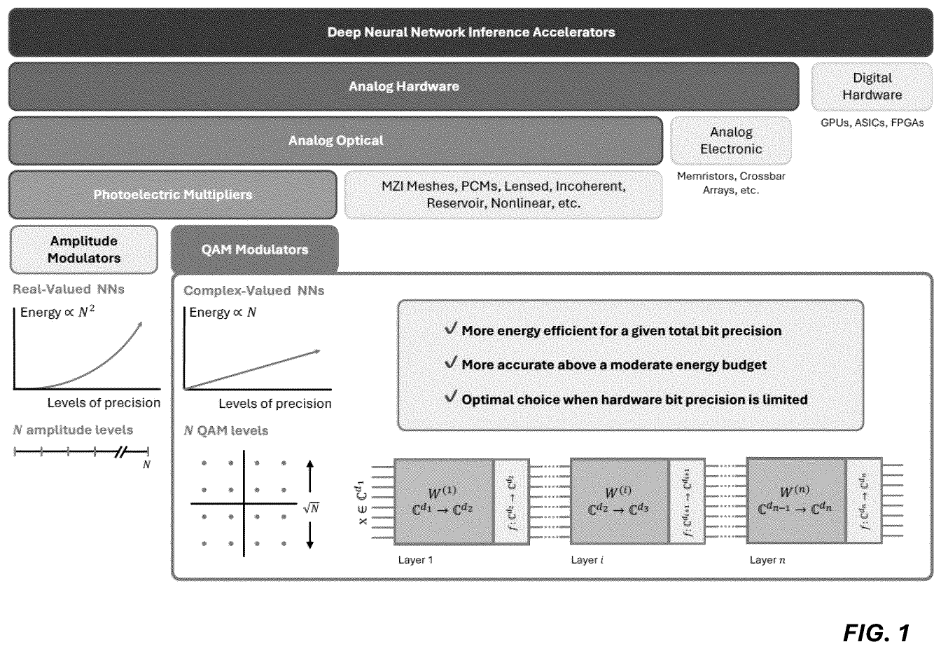

FIG. 1 shows a taxonomy of Deep Neural Network (DNN) inference accelerators, with emphasis on the design space decisions that motivate the exploration of analog optical accelerators. At a high level, DNN inference accelerators can be divided into those that use digital hardware, such as graphics processing units (GPUs), application-specific integrated circuits (ASICs), and field-programmable gate arrays (FPGAs), and those that use analog hardware. Analog computing offers a compelling alternative to digital hardware due to opportunities for parallelism, lower energy consumption not limited by transistor switching energy, and integration with co-designed sensors.

Analog DNN inference accelerators include both analog electronic DNN inference accelerators and analog optical DNN inference accelerators. Analog electronic DNN inference accelerators include memristor crossbar arrays, phase change memory, and capacitor-based schemes. Analog optical computing offers new paradigms of parallelism and includes approaches like Mach-Zehnder interferometer (MZI) meshes, lensed free-space schemes, nonlinear optical materials, and photoelectric multipliers. Photoelectric multipliers can be subdivided into those with amplitude modulators, for real-valued neural networks, and those with quadrature amplitude modulation (QAM) modulators, for complex-valued neural networks. Analog DNN inference accelerators with photoelectric multiplication using QAM modulators offer linear growth in energy consumption with the number of levels of precision as shown at the bottom of FIG. 1.

Analog implementations of neural networks use quantization, where digitally represented full-precision values are discretized into a fixed and typically lower number of levels that the hardware can implement. Each matrix and vector element value is usually represented as a signal modulated in intensity or real-valued amplitude (positive and negative). Analog values, despite being continuous in theory, should respect a minimum distinguishable step size between successive signal levels. This step size A is lower-bounded by the noise level of the digital-to-analog converter (DAC) used to discretize the digital values, since if two signal levels differ by less than Δ units of energy, they will be indistinguishable in the presence of noise of amplitude Δ. Therefore, in real amplitude modulation schemes, representing N unique levels takes [(N−1)Δ/2]² units of energy.

An analog DNN inference accelerator that uses complex amplitude modulation can operate with energy consumption that scales linearly with the number of levels. More specifically, a QAM-based optical neural network (ONN)—QAMNet—uses a photoelectric multiplication scheme to efficiently calculate complex-valued inner products of I/Q modulated signals. This scheme can be readily implemented with telecommunications-grade QAM modulators to accurately accelerate complex-value neural network inference, indicating an opportunity for efficient edge-device DNN inference using appropriately modified telecommunications equipment.

A QAMNet end-to-end information processing system maps real-valued inputs to complex values, which are then processed with a complex-valued neural network implemented on QAM hardware. Comparing this system to level equivalent, hardware equivalent, and energy equivalent 1D ONNs shows different regimes of advantage of QAMNet over 1D counterparts. As discussed in greater detail below:
A Level Equivalent comparison reveals that QAMNet is significantly more energy-efficient than its 1D counterparts: for an equivalent number of total levels, QAMNet uses quadratically less energy. This efficiency is attributed to the ability of QAMNet to utilize two modulators in parallel, achieving the same number of unique levels with reduced power consumption. Consequently, QAMNet achieves higher accuracy with less energy, making it a preferable choice in energy-constrained scenarios.
A Hardware Equivalent comparison demonstrates that when hardware bit precision is limited, QAMNet consistently demonstrates superior performance by leveraging two modulators for I/Q modulation. QAMNet outperforms 1D ONNs in terms of accuracy due to the quadratic increase in total levels achievable by QAMNet compared to the linear increase in 1D ONNs. Thus, QAMNet is an optimal strategy for low-power and low-cost devices where hardware precision is a constraint.
An Energy Equivalent comparison further illustrates the efficiency of QAMNet, showing that as the total energy allotment increases, QAMNet achieves higher accuracies than 1D ONNs. Using the same amount of energy for total levels is more useful in QAM than in 1D ONNs.

QAMNet offers substantial benefits over 1D ONNs across various metrics. QAM-based ONNs like QAMNet can achieve higher accuracy at lower energies for a given bit precision, attain higher overall accuracies above moderate energy budgets, and are an optimal choice when hardware bit precision is limited. As DNN intelligence becomes increasingly prominent on edge devices and in power-constrained environments, QAMNet offers a compelling balance of efficiency and performance.

### I/Q Photoelectric Multiplication

QAMNet uses an I/Q modulation-based photoelectric multiplication scheme that supports complex-valued multiply-accumulate operations for efficient complex-valued inner product computation. The same hardware can be used to perform real-valued inner products twice as fast as an amplitude modulation photoelectric multiplication scheme.

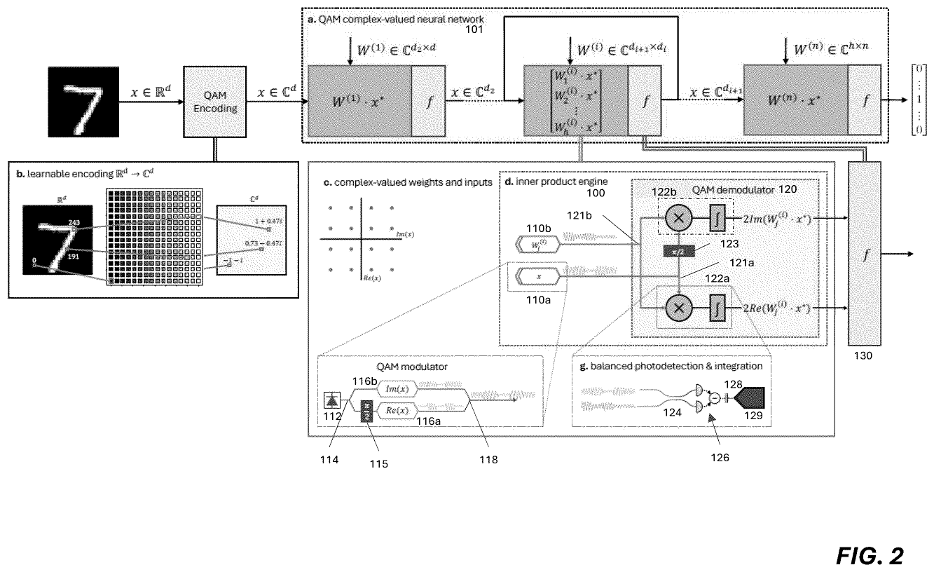

FIG. 2 illustrates a QAMNet complex-valued inner product engine 100, also called an I/Q photoelectric multiplier, that uses photoelectric multiplication to compute the complex-valued inner product of I/Q encoded input and weight values for one layer of a multi-layer perceptron neural network. The inner product engine 100 includes a pair of QAM modulators 110a and 110b coupled to inputs of a QAM demodulator 120 via respective beam splitters 121a and 121b. The QAM demodulator 120 includes two mixers and integrators 122a and 122b whose outputs are digitized with respective analog-to-digital converters (ADCs) 129 and fed to a digital processor 130 that implements the nonlinearity for the neural network layer.

Each QAM modulator 110a, 110b includes a pair of amplitude modulators 116a, 116b (e.g., Mach-Zehnder modulators) via a first beam splitter 114 with a π/2 phase shift 115 at one output. A second beam splitter 118 is coupled to the outputs of the amplitude modulators 116a, 116b. In operation, a laser 112 emits an optical carrier wave (a laser beam), which the first 50:50 beam splitter 114 divides and directs to the amplitude modulators 116a, 116b, one of which is driven with the imaginary part of the input signal (e.g., the input or weight for the neural network) and other of which is driven with the real part of the input signal. In other words, the amplitude modulators 116a, 116b are used off-phase to perform phase and amplitude modulation. (A single laser 112 can drive both QAM modulators 110a, 110b simultaneously via a 1×2 beam splitter that separates the output of the laser 112 into first and second optical carrier waves for the first and second QAM modulators 110a, 110b, respectively.) The second beam splitter 118 combines the outputs of the amplitude modulators 116a, 116b to produce an I/Q encoded optical signal suitable for photoelectric multiplication.

FIG. 2 also shows an optical implementation of the QAM demodulator 120. The QAM demodulator 120 is like a standard QAM demodulator, albeit modified with an I/Q modulator for weights 110b replacing the standard QAM demodulator's local oscillator. Each mixer in the QAM demodulator 120 is implemented as a 2×2 beam splitter 124 (depicted in FIG. 2 as an evanescent coupler) with one input coupled to QAM modulator 110a and the other input coupled to QAM modulator 110b via beam splitter 121a or 121b. (A π/2 phase shift at one output of beam splitter 121a shifts the phase of the input I/Q signal with respect to the phase of the weight I/Q signal that together drive the mixer and integrator 122b.) The outputs of the 2×2 beam splitter 124 are coupled to respective inputs of a balanced photodetector 126, which transduces the incident optical signals into photocurrents. Each integrator in the QAM demodulator 120 can be implemented as a capacitor 128 or other capacitance that collects and integrates the difference photocurrent from the corresponding balanced photodetector 126. The ADC 129 coupled to the capacitor digitizes the integrated photocurrent and transmits the resulting digital representation to the digital processor 130, which applies a ReLU or other nonlinear function to the signals.

The upper portion of FIG. 2 shows an algebraic representation of the complex-valued multi-layer perceptron neural network inference 101 performed by the inner product engine 100. In this inference 101, a linear neural network layer with input dimension dᵢ and output dimension dᵢ₊₁ is parameterized by weight matrices W⁽ⁱ⁾ ∈ [symbol] ^{d}^{ᵢ₊₁}^{×d}^{ᵢ} and a nonlinear function ƒ: [symbol] ^{d}^{ᵢ₊₁}→ [symbol] ^{d}^{ᵢ₊₁}. Layer i shows details of the inner products computed during inference. A learnable encoding [symbol] (FIG. 2, left) maps real-valued data to complex-valued data of the same dimension. The resulting complex-valued weights and inputs represented as symbols in a QAM constellation (FIG. 2, center).

In the QAMNet complex-valued inner product engine of FIG. 2, a complex-valued weight or input is modulated onto an optical carrier wave in I/Q space, where the In-phase and Quadrature (I/Q) components represent the real and imaginary parts, respectively, of the weight w or input x. This allows each I/Q-encoded symbol to represent a point in the complex plane, shown at the center of FIG. 2. A signal in I/Q space can be represented in the time domain as Equation (1) (below), where the in-phase and quadrature components are modulated in amplitude on two out-of-phase optical carriers of frequency ω and combined using the QAM modulators 110a, 110b. QAM modulators 110a modulates the j'th element of a complex-valued input vector x onto the optical carrier wave as:

$${s}_{j} ( t ) = Re ( {x}_{j} ) cos ( ωt ) + Im ( {x}_{j} ) sin ( ωt ) . \qquad ( 1 )$$

Equation (1) can be rewritten in phasor notation as Equation (2), highlighting the amplitude and phase of the modulated value:

$$\begin{matrix}{s}_{j} ( t ) = {A}_{j} {e}^{i ( ωt + {ϕ}_{j} )} \\ \begin{matrix}{A}_{j} = \sqrt{{Re ( {x}_{j} )}^{2} + {Im ( {x}_{j} )}^{2}} & {ϕ}_{j} = arctan ( \frac{Im ( {x}_{j} )}{Re ( {x}_{j} )} )\end{matrix}\end{matrix} \qquad ( 2 )$$

The weight values w are encoded in the same way. As shown in FIG. 2, each I/Q-encoded input and weight value is fanned out into two beam paths by beam splitters 121a and 121b. Each beam path leads to a balanced photodetector 126 with an electronic integrator (capacitance) 128, shown in FIG. 2. The beam splitters 121a, 121b each have a transfer matrix of

$$\frac{1}{\sqrt{2}} [ \begin{matrix}1 & 1 \\ 1 & - 1\end{matrix} ] ,$$

but with a π/2 phase shift 123 applied to one of the inputs at the top path. The balanced photodetectors 128 take the differences of the photocurrents, yielding accumulated charge proportional to

$$2 Im ( {w}_{j} {x}_{j}^{*} ) and 2 Re ( {w}_{j} {x}_{j}^{*} )$$

in the top and bottom beam paths, respectively.

The capacitors 128 integrate the photocurrents produced by these individual scalar multiplications over time to yield inner products at the top and bottom beam paths. The charges on the capacitors 128 are proportional to

$${\sum }_{j = 1}^{n} Im ( {w}_{j} {x}_{j}^{*} ) and {\sum }_{j = 1}^{n} Re ( {w}_{j} {x}_{j}^{*} )$$

on the top and bottom beam paths, respectively, thereby yielding the real and imaginary components of the desired complex-valued inner product w·x* (see below for full derivation).
Complex-Valued Neural Network Inference with Telecom QAM Modulators

Telecommunications hardware can be used for accelerating complex-valued neural network (CVNN) inference. The digital QAM modulators and demodulators in telecommunications equipment can be used as modulators and mixers, respectively, in an I/Q photoelectric multiplier, e.g., as shown in FIG. 2. These digital QAM modulators transmit discrete symbols with discrete I and Q values, the set of which comprises the modulator's constellation, which is typically arranged as a square grid with equal vertical and horizontal spacing, and measured by the number of points on each axis (QAM side). This fixed set of constellation points means that every complex-valued weight and input activation in the CVNN should be quantized to a constellation point. Furthermore, non-idealities in modulators and photodetector responses result in noisy output signals. An I/Q photoelectric multiplier enables accurate inference of a deep CVNN, even under realistic noise and quantization figures.

QAMNet ONN hardware can be used to accelerate existing CVNNs, including the Deep Signal Network (DSN) model applied to the RadioML 2016.10A dataset, which is classification of a sequence of I/Q samples into 11 modulation format classes. To demonstrate this improvement, we trained a DSN model and then transferred the weights of the trained DSN model to a QAMNet ONN using a standard post-training quantization strategy. Because the real and imaginary components of the inner product (each output element of the matrix multiplication of inputs and weights) are read out by separate ADCs in the QAMNet ONN, these real and imaginary components receive independent and identically distributed noise. The total noise from the digital-to-analog converter (DAC), modulator, photodetectors, and ADCs in the QAMNet ONN is modeled as a Gaussian random variable with zero mean and a standard deviation given by σₙₒᵢₛₑ=σ_{signal}/\sqrt{SNR}.

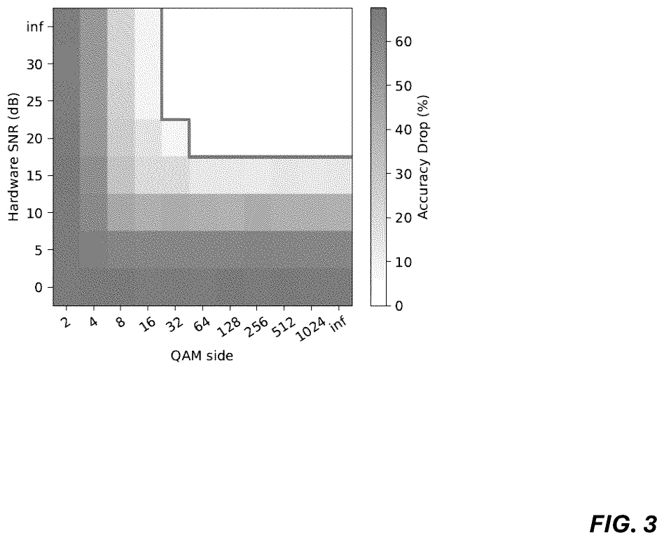

FIG. 3 shows the accuracy degradation under different combinations of QAM constellation size and SNR compared to a digitally run neural network with infinite SNR and essentially infinite QAM constellation size. It shows that decreasing constellation size (measured by QAM side) and hardware SNR both degrade inference accuracy. The outlined area in FIG. 3, highlighting the combinations that result in less than 5% loss in accuracy, is roughly the regime of QAM side≥32 levels and ≥20 db of SNR. These results suggest that implementing an I/Q photoelectric multiplier using conventional, off-the-shelf QAM modulators (which typically have over 20 dB of SNR) should not reduce accuracy significantly. Using 256-QAM modulators (16 levels per side of modulation) and a moderate 30 dB of SNR results in an accuracy drop of only 7.3%. While accuracy degradation from quantization and noise is highly model-dependent, these findings indicate the broader feasibility of deploying deep CVNNs using commodity telecommunications hardware. These results demonstrate the feasibility of implementing pre-trained CVNNs on QAM hardware for complex-valued datasets.

### QAMNet: Model-Hardware Trade-Offs for QAM-Based Optical Neural Networks

This section compares the performance of QAMNet complex-valued neural networks implemented with I/Q photoelectric multiplication against real-valued neural networks implemented with amplitude photoelectric multipliers (1D ONNs). QAMNet uses standard QAM modulators with finite precision for I/Q photoelectric multiplication, while 1D ONNs use a single axis of amplitude modulation. This comparison uses real-valued datasets.

Because the MNIST family of image classification tasks contain real-valued inputs, QAMNet uses a trainable embedding layer, inspired by word2vec, to map each real-valued input pixel value to a complex number (e.g., as in FIG. 2). These complex values are then processed with a complex-valued neural network implemented with I/Q photoelectric multipliers as discussed above. The mapping from [symbol] ^{d}→ [symbol] ^{d} is expressed as repeatedly applying (d times) the map [symbol] → [symbol] , which is structurally equivalent to applying the map [symbol] → [symbol] . In the case of MNIST-style images (e.g., as shown in FIG. 2), this map corresponds to an embedding from a vocabulary of length 256 (the total number of possible pixel values) to a vector space of dimension 2. Embeddings like this can be readily implemented with a lookup table that requires no MAC operations, making this a feasible approach for edge devices. During training, the embedding layer is differentiable and is trained alongside the rest of the network using backprop.

### Evaluation Principles

One particularly promising use case of optical neural networks is in low-power edge device intelligence, using schemes such as the Netcast scheme disclosed in U.S. Pre-Grant Publication No. 2023/0274156, entitled “Low-Power Edge Computing with Optical Neural Networks via WDM Weight Broadcasting,” which is incorporated herein by reference in its entirety. Edge devices are characterized by tight constraints on cost, energy, and memory, and often, the desire for low latency and high throughput neural network inference. In edge devices operating under low memory constraints, any data on the edge device must be minimized, including both the input data size and the layer activations that are stored during inference.

In the context of edge devices, consider multi-layer perceptrons with low neuron counts and two layers. The latency of inference scales linearly with the number of neurons, motivating the study of neurons with low neuron counts. The amount of storage on the edge device grows with the size of the intermediate layer activations that should be stored between the computation of one layer and the next. With the same motivations, we benchmark on the MNIST dataset down-sampled to 7×7 pixels.

### Energy Consumption of Activations

In Netcast, a client performing DNN inference receives weights streamed from a centralized weight server and uses the transmitted weights directly in photoelectric multiplication. As a result, a client need only modulate the DNN's input and each layer's input activations, dramatically reducing its onboard energy and memory requirements. Consider a multi-layer perceptron (MLP) with L layers, with the number of neurons at layer defined as h, where h₀ is the input dimension, hᵢ for 1≤i≤L is the number of neurons at the i'th hidden layer, and h_{L+1} is the number of classes in the output layer. For a 1D ONN and QAMNet with N total levels, the total client energy consumption is the number of values to be modulated multiplied by the energy per modulation:

$$1 D ONN Energy : ( {\sum }_{i} {h}_{i} ) \times {( \frac{N - 1}{2} )}^{2} \qquad ( 3 )$$

$$QAMNet Energy : 2 \times ( {\sum }_{i} {h}_{i} ) \times {( \frac{\sqrt{N} - 1}{2} )}^{2} \qquad ( 4 )$$

### Terminology for Comparison

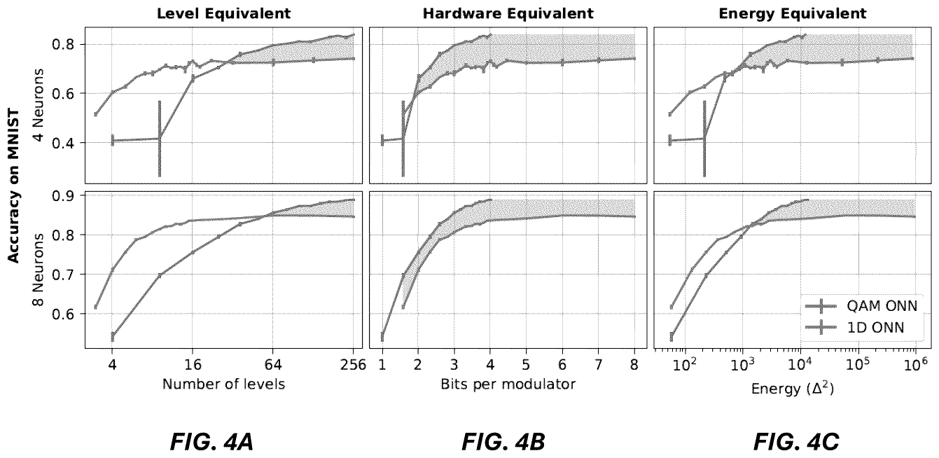

When picking the parameters for a 1D ONN to compare against QAMNet, there are multiple design decisions that can be explored, depending on what is kept constant. FIGS. 4A-4C, for example, show accuracy comparisons between QAMNet and the three comparison classes shown TABLE 1 on the MNIST dataset. These comparison classes are level equivalent (FIG. 4A), hardware equivalent (FIG. 4B), and energy equivalent (FIG. 4C) 1D ONNs.

The term value refers to a single real number used in a network's parameterization. In QAMNet, each complex-valued weight is composed of two values. In a 1D ONN, a single real-valued weight corresponds to a single value. Each weight is modulated with a total number of levels. In QAMNet, the total number of levels

$${N}_{total} = {N}_{side}^{2}$$

is the number of constellation points, where N_{side} is the number of levels realizable by a single modulator. In 1D ONNs, the total number of levels is simply the number of levels realizable by the single modulator. Each modulator can realize a certain number of levels, whose equivalent bit precision is denoted as #Bits per value. The maximum power required for a single amplitude modulator to represent a single value is the square of the maximum amplitude. Because the minimum spacing of amplitudes is lower-bounded by the noise Δ around each symbol, for a number of levels L of a single value, the energy per value is computed as ((L−1)/2)²Δ².

### Level Equivalent Comparison

FIG. 4A shows a comparison of QAMNet ONNs to level equivalent 1D ONNs. This equivalence perspective highlights the relationship between quantization levels in 1D ONNs compared to quantization levels in QAMNet. At extremely low numbers of levels, the 1D ONN achieves higher accuracy than QAMNet, possibly because gradients computed during backprop become significantly inaccurate with a low number of levels per value. However, as the number of levels increase and accuracy is not limited by quantization effects on training, QAMNet achieves higher accuracies than the 1D ONNs. The crossover point seems to move to the right as the network size increases, suggesting that the advantage of QAMNet is most significant in low-power and low-precision hardware environments.

### Hardware Equivalent Comparison

FIG. 4B shows a comparison of QAMNet ONNs to hardware equivalent 1D ONNs. In low-power and low-cost devices, size weight and power (SWAP), cost, and supply chain limitations often restrict the maximum precision of available modulators. In these scenarios, QAMNet consistently matches or surpasses the performance of traditional 1D ONNs. For a fixed bit precision per amplitude modulator, QAMNet can achieve superior performance by using two modulators together for I/Q photoelectric multiplication, compared to a 1D ONN that uses one amplitude modulator. Linearly increasing the number of levels of a modulator results in a linear increase in total levels in 1D ONNs, but a quadratic increase in total levels in QAMNet. As a result, QAMNet consistently achieves higher accuracy than even 1D ONNs that have far greater modulator precision.

### Energy Equivalent Comparison

FIG. 4C shows a comparison of QAMNet ONNs to energy equivalent 1D ONNs. In this comparison, the total energy of the 1D ONN matches that of QAMNet by increasing the number of levels in the 1D ONN to the next largest integer value (see the formula in “Energy Equivalent 1D” in TABLE 1). The total energy is computed as the number of activation values multiplied by the power required to realize each value. At extremely low energy budgets, QAMNet performs slightly worse than 1D ONNs due to training instability and sub-optimal convergence with low precision quantization. Above moderate energy budgets, QAMNet demonstrates a clear accuracy advantage over 1D ONNs. For the same energy per value of ((\sqrt{N}−1)/2) Δ², QAMNet can represent N total levels, while the hardware equivalent 1D ONN can represent only \sqrt{N} total levels. As a result, for the same energy utilization, QAMNet achieves overall higher accuracies than 1D ONNs.

### Comparison Methods

For the comparisons shown in FIGS. 4A-4C, post-training quantization of the CVNN was performed by finding scaling and zero-point factors for each inner product, which corresponds to independent factors for each neuron. Quantization is simulated by scaling and shifting to the range [−1,1], applying the uniform quantizer to those values, and then computing the unscaled output.

The QAMNet and 1D ONN models were trained using quantization-aware training (QAT), where weights and inputs were quantized to the QAM constellation during the forward pass, while full precision weights and inputs were used to compute gradients in the backward pass based on the error of the quantized weights and inputs. For small networks, this yields better accuracy than post-training quantization.

During backpropagation, gradients of the quantization function were computed with the straight-through estimator. In the forward pass, weights W and inputs x were quantized with a function Q, such that each layer's post-activation output is computed as

$$y = f ( Q ( W ) Q ( {x}^{*} ) ) ,$$

where f is the desired nonlinear activation. In the comparisons above, quantization-aware training is simulated as a uniform quantizer with a fixed dynamic range of [−1,1]. Specifically, the derivative of the quantization function is set to be

$$\frac{\partial }{\partial x} Q ( x ) \approx \{ \begin{matrix}1 & if - 1 \leq x \leq 1 \\ 0 & otherwise\end{matrix} .$$

The smallest network sizes and lowest precision quantization (four hidden neurons and 4-16 levels) experience some fluctuations in accuracy due to training instability arising from the effect of weight oscillations, a well-known phenomenon when using very low bit precision quantization-aware training. Nevertheless, these do not affect the overall results, and their effect diminishes at higher levels of quantization.

### I/Q-Based Complex-Valued Inner Products

In considering the workings of the I/Q inner product engine, the top and bottom mixer beam paths of FIG. 2 behave similarly. In what follows, their real and imaginary parts are denoted with superscripts^{(r)} and ⁽ⁱ⁾for notational simplicity.

The two I/Q modulated passband signals entering the homodyne demodulator are

$${s}_{1} ( t ) = ( {w}_{j}^{( r )} + i {w}_{j}^{( i )} ) {e}^{i ω t} and {s}_{2} ( t ) = ( {x}_{j}^{( r )} + i {x}_{j}^{( i )} ) {e}^{i ω t} ,$$

where ω is the carrier frequency of the optical carrier wave. In the upper beam path, the mixer's effective transition matrix combines a beam splitter matrix and a 90° phase shift on one input port. For the j'th element of the inner product w·x*, the signals entering the balanced photodetectors are

$$\frac{1}{\sqrt{2}} [ \begin{matrix}1 & 1 \\ 1 & - 1\end{matrix} ] [ \begin{matrix}i & 0 \\ 0 & 1\end{matrix} ] [ \begin{matrix}( {w}_{j}^{( r )} + i {w}_{j}^{( i )} ) {e}^{i ω t} \\ ( {x}_{j}^{( r )} + {ix}_{j}^{( i )} ) {e}^{i ω t}\end{matrix} ] = \frac{1}{\sqrt{2}} [ \begin{matrix}( {x}_{j}^{( r )} - {w}_{j}^{( i )} + i ( {w}_{j}^{( r )} + {x}_{j}^{( i )} ) ) {e}^{i ω t} \\ ( - {x}_{j}^{( r )} - {w}_{j}^{( i )} + i ( {w}_{j}^{( r )} - {x}_{j}^{( i )} ) ) {e}^{i ω t}\end{matrix} ]$$

From each output port of the homodyne mixer, the photocurrents for the j'th element of the inner product w·x* are the squared output intensities:

$$\begin{matrix}{I}_{j}^{+} = \frac{1}{2} {‖ {x}_{j}^{( r )} - {w}_{j}^{( i )} + i ( {w}_{j}^{( r )} + {x}_{j}^{( i )} ) ‖}^{2} \\ {I}_{j}^{-} = \frac{1}{2} {‖ - {x}_{j}^{( r )} - {w}_{j}^{( i )} + i ( {w}_{j}^{( r )} - {x}_{j}^{( i )} ) ‖}^{2}\end{matrix}$$

Summing the difference of these intensities over the elements of j yields the desired inner product:

$${\sum }_{j} {I}_{j}^{+} - {I}_{j}^{-} = {\sum }_{j} 2 ( {w}_{j}^{( r )} {x}_{j}^{( i )} - {w}_{j}^{( i )} {x}_{j}^{( r )} ) = 2 Im ( w \cdot {x}^{*} )$$

In the bottom beam path, the same analysis can be applied, omitting the 900 phase shift, yielding the result 2Re(w·x*).

### Doubly Fast Real-Valued Dot Products

The inner product of two real-valued length-n vectors \vec{a}=[a₁, a₂, . . . , aₙ] and \vec{b}=[b₁, b₂, . . . , bₙ] can be expressed as the sum of n/2 inner products of length-2 vectors:

$$\begin{matrix}\vec{a} \cdot \vec{b} = {\sum }_{i = 1}^{n / 2} ( {a}_{2 i} {b}_{2 i} + {a}_{2 i + 1} {b}_{2 i + 1} ) \\ = {\sum }_{i = 1}^{n / 2} Re ( ( {a}_{2 i} + i {a}_{2 i + 1} ) {( {b}_{2 i} + i {b}_{2 i + 1} )}^{*} )\end{matrix}$$

The inner product of two length-2 vectors [a,b]·[c,d] can be computed as the real component of the complex-valued multiplication, Re((a+ib)(c+id)*). This computation happens in a single time step at one mixer's output of the I/Q photoelectric multiplier. Therefore, by rolling length-n real-valued vectors into n/2 length-2 vectors by using every other value as the complex component of its preceding real value, the inner product of two length-n vectors can be computed in n/2 time steps using the I/Q photoelectric multiplier.

### Comparison to Alternative Designs

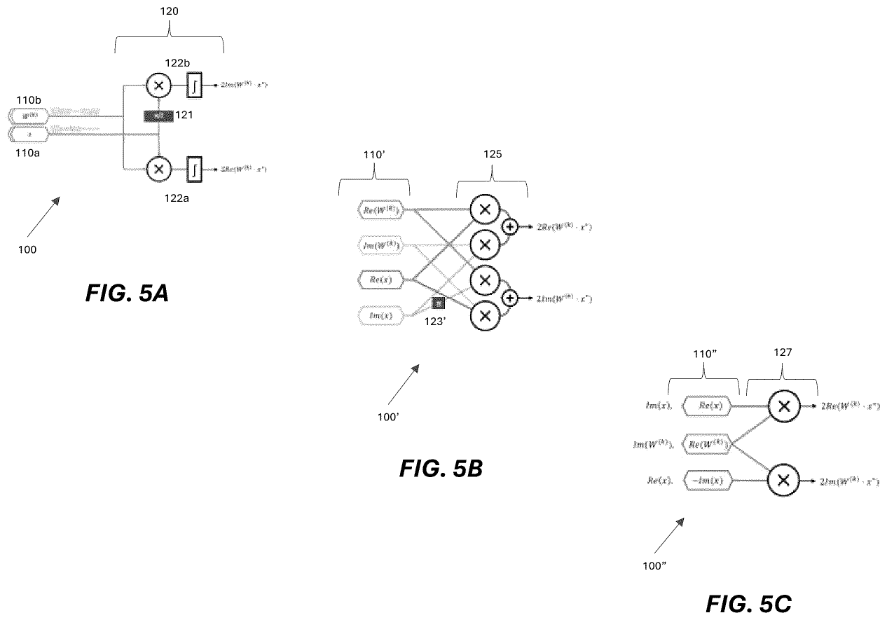

TABLE 2 compares the I/Q photoelectric multiplier 100 shown in FIG. 2 and reproduced in FIG. 5A with alternative complex-valued inner product engines 100′ and 100” that use amplitude-only modulation shown in FIGS. 5B and 5C. The amplitude-only inner product engine 100′ in FIG. 5B uses four modulators 110′ with outputs representing the partial sums ac, bd, −ad, and bc, with each operand modulated once and fanned out into two mixers 125. To achieve the negative sign on the −ad term, a π phase shift 123′ is applied on the beam path of Im(x). The partial sum terms are then added in analog electronics, yielding the real and imaginary components when summed together. The complex-valued multiplier 100” in FIG. 5C includes two mixers 127 and three modulators 110”, but takes two time steps to accumulate the real and imaginary components. The QAMNet I/Q photoelectric multiplier 100 in FIG. 5A uses two mixers 122a, 122b and two QAM modulators 110a, 110b (each with two amplitude modulators, or four modulators total) for one time step, resulting in the most efficient implementation.

TABLE 2
Comparison of I/Q Photoelectric Multiplication with alternative
amplitude-only schemes for complex-valued inner products.
The number of timesteps is shown for computing a single complex-
valued multiplication of W^{(k)}x *.

| | I/Q Photoelectric | | |
|---|---|---|---|
| | Multiplication | 4 Inner Product | 2 Mixers |
| Type | (FIG. 5A) | Engines (FIG. 5B) | (FIG. 5C) |
| Value Type | Complex-Valued | Real-Valued | Real-Valued |
| Modulators | 4 (2 per I/Q | 4 | 3 |
| | modulator) | | |
| Mixers | 2 | 4 | 2 |
| Time Steps | 1 | 1 | 2 |

### Other Datasets

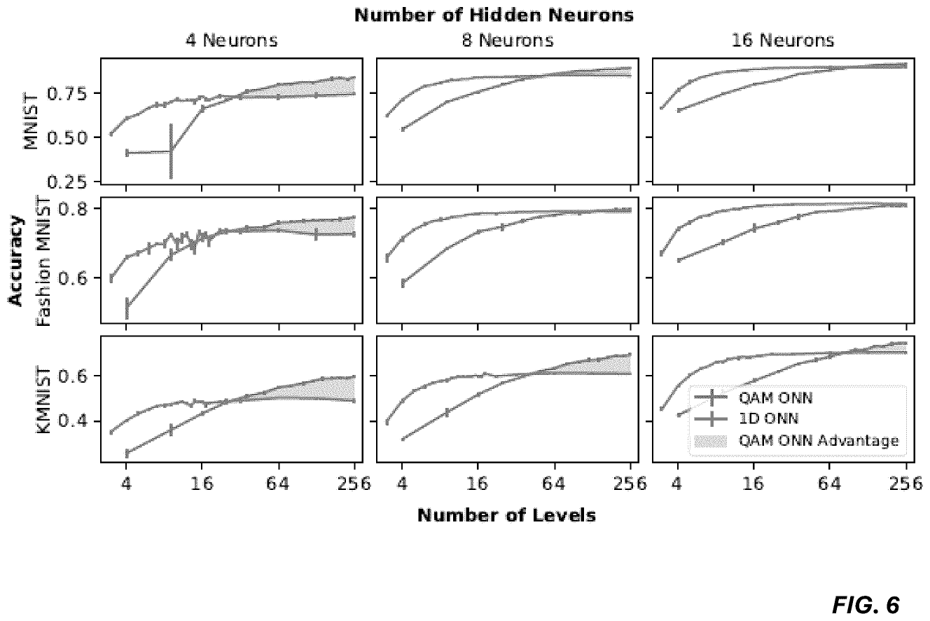

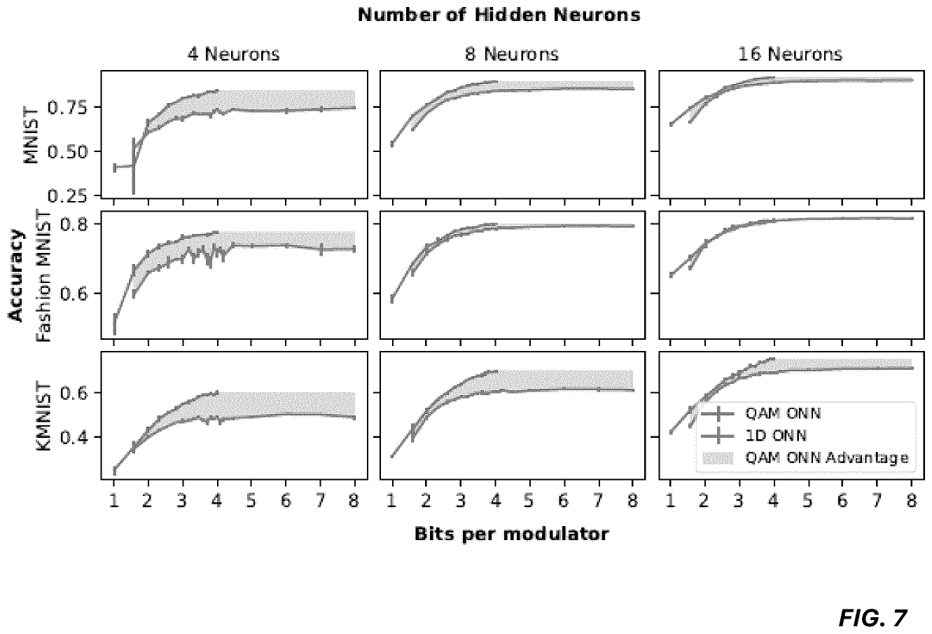

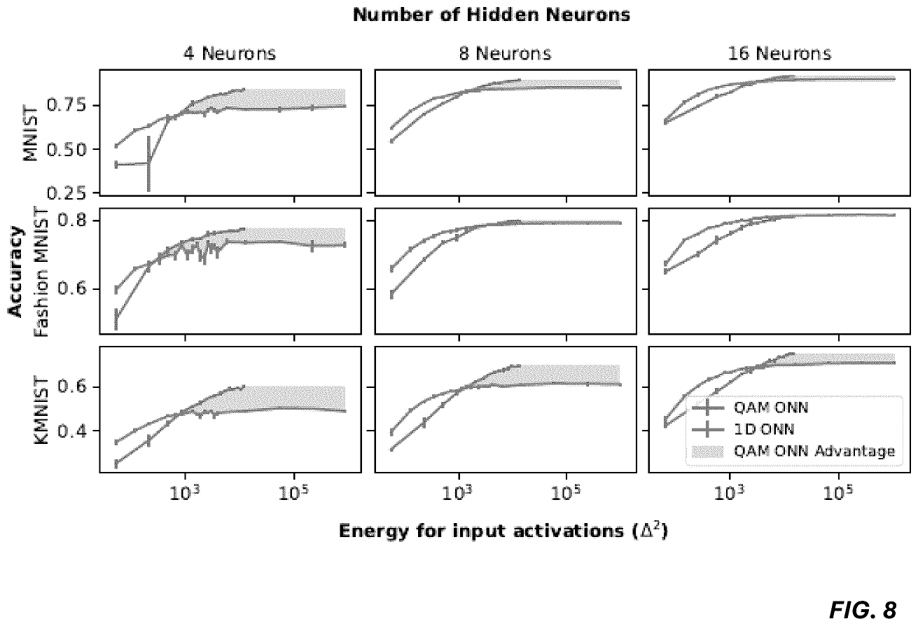

In addition to the MNIST dataset, FIGS. 6-8 include benchmarks on the similar Fashion MNIST and KMNIST datasets for 2-layer networks with 4, 8, and 16 neurons in the hidden layer. Some training instability arises from weight oscillations at few neurons and low levels of quantization. FIGS. 6, 7, and 8 show full results for the level equivalence, hardware equivalence, and energy equivalence perspectives, respectively.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein.

The foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An optical neural network comprising:
a first quadrature-amplitude (QAM) modulator to modulate real and imaginary components of a complex-valued input to a layer of the optical neural network onto in-phase and quadrature components, respectively, of a first optical carrier wave;
a second QAM modulator to modulate real and imaginary components of a complex-valued weight of the optical neural network onto in-phase and quadrature components, respectively, of a second optical carrier wave;
a first beam splitter, in optical communication with the first QAM modulator and the second QAM modulator, to interfere a first portion of the first optical carrier wave with a first portion of the second optical carrier wave;
a second beam splitter, in optical communication with the first QAM modulator and the second QAM modulator, to interfere a second portion of the first optical carrier wave with a second portion of the second optical carrier wave;
a first balanced photodetector, in optical communication with the first beam splitter, to detect interference of the first portion of the first optical carrier wave and the first portion of the second optical carrier wave, the interference of the first portion of the first optical carrier wave and the first portion of the second optical carrier wave representing a real component of a product of the complex-valued input and the complex-valued weight; and
a second balanced photodetector, in optical communication with the second beam splitter, to detect interference of the second portion of the first optical carrier wave and the second portion of the second optical carrier wave, the interference of the second portion of the first optical carrier wave and the second portion of the second optical carrier wave representing an imaginary component of the product of the complex-valued input and the complex-valued weight.

2. The optical neural network of claim 1, wherein the first QAM modulator comprises:
an input beam splitter to split the first optical carrier wave into an in-phase portion and a quadrature portion;
a phase shift, in optical communication with a first output of the input beam splitter, to shift a phase of the quadrature portion of the first optical carrier wave with respect to a phase of the in-phase portion of the first optical carrier wave;
a first amplitude modulator, in optical communication with the first output of the input beam splitter, to modulate an amplitude of the quadrature portion of the first optical carrier wave with the real component of the complex-valued input;
a second amplitude modulator, in optical communication with a second output of the input beam splitter, to modulate an amplitude of the in-phase portion of the first optical carrier wave with the imaginary component of the complex-valued input; and
an output beam splitter, in optical communication with the first amplitude modulator and the second amplitude modulator, to combine the in-phase portion of the first optical carrier wave and the quadrature portion of the first optical carrier wave.

3. The optical neural network of claim 1, further comprising:
a capacitance, in electrical communication with the first balanced photodetector, to integrate a photocurrent emitted by the first balanced photodetector representing the real component of the product of the complex-valued input and the complex-valued weight.

4. The optical neural network of claim 3, further comprising:
an analog-to-digital converter (ADC), in electrical communication with the capacitance, to generate a digital representation of the photocurrent integrated by the capacitance.

5. The optical neural network of claim 4, further comprising:
a digital processor, operably coupled to the ADC, to apply a nonlinearity to the digital representation.

6. A method of inference processing, the method comprising:
modulating real and imaginary components of a complex-valued input to a layer of an optical neural network onto in-phase and quadrature components, respectively, of a first optical carrier wave;
modulating real and imaginary components of a complex-valued weight of the optical neural network onto in-phase and quadrature components, respectively, of a second optical carrier wave;
detecting interference of a first portion of the first optical carrier wave and a first portion of the second optical carrier wave, the interference of the first portion of the first optical carrier wave and the first portion of the second optical carrier wave representing a real component of a product of the complex-valued input and the complex-valued weight; and
detecting interference of a second portion of the first optical carrier wave and a second portion of the second optical carrier wave, the interference of the second portion of the first optical carrier wave and the second portion of the second optical carrier wave representing an imaginary component of the product of the complex-valued input and the complex-valued weight.

7. The method of claim 6, wherein modulating the real and imaginary components of the complex-valued input onto the in-phase and quadrature components of the first optical carrier wave comprises:
splitting the first optical carrier wave into an in-phase portion and a quadrature portion;
shifting a phase of the quadrature portion of the first optical carrier wave with respect to a phase of the in-phase portion of the first optical carrier wave;
modulating an amplitude of the in-phase portion of the first optical carrier wave with an imaginary portion of the complex-valued input;
modulating an amplitude of the quadrature portion of the first optical carrier wave with a real portion of the complex-valued input; and
combining the in-phase portion of the first optical carrier wave and the quadrature portion of the first optical carrier wave.

8. The method of claim 6, wherein detecting interference of the first portion of the first optical carrier wave and the first portion of the second optical carrier wave comprises:
transducing, with a balanced photodetector, the interference into a photocurrent.

9. The method of claim 8, further comprising:
integrating, with a capacitance, the photocurrent over time.

10. The method of claim 9, further comprising:
generating a digital representation of the photocurrent; and
applying, with a digital processor, a nonlinearity to the digital representation.

11. The method of claim 6, further comprising:
generating the complex-valued input by mapping a real-valued input to the complex plane.

12. An optical neural network comprising:
a first quadrature-amplitude modulation (QAM) modulator to modulate a first optical carrier wave with a QAM representation of an input to a layer of the optical neural network;
a second QAM modulator to modulate a second optical carrier wave with a QAM representation of a weight of a layer of the optical neural network; and
a QAM demodulator, optically coupled to the first QAM modulator and the second QAM modulator, to perform in-phase/quadrature (I/Q) photoelectric multiplication of the QAM representation of the input and the QAM representation of the weight.

13. The optical neural network of claim 12, wherein at least one of the input or the weight is complex-valued.

14. The optical neural network of claim 12, wherein the first QAM modulator comprises:
a first beam splitter to split the first optical carrier wave into a first portion and a second portion;
a first amplitude modulator, operably coupled to a first output of the first beam splitter, to modulate an amplitude of the first portion of the first optical carrier wave with an imaginary component of the input;
a phase shifter, operably coupled to a second output of the first beam splitter, to shift a phase of the second portion with respect to a phase of the first portion;
a second amplitude modulator, operably coupled to the phase shifter, to modulate an amplitude of the second portion of the first optical carrier wave with a real component of the input; and
a second beam splitter, operably coupled to the first amplitude modulator and the second amplitude modulator, to combine the first portion of the first optical carrier wave and the second portion of the first optical carrier wave.

15. The optical neural network of claim 12, where the QAM demodulator comprises:
a first mixer to mix an in-phase component of the first optical carrier wave with an in-phase component of the second optical carrier wave;
a first integrator, operably coupled to the first mixer, to integrate an output of the first mixer over time;
a second mixer to mix a quadrature component of the first optical carrier wave with a quadrature component of the second optical carrier wave; and
a second integrator, operably coupled to the second mixer, to integrate an output of the second mixer over time.

16. The optical neural network of claim 15, wherein the first mixer comprises:
a beam splitter to combine the in-phase component of the first optical carrier wave and the in-phase component of the second optical carrier wave; and
a balanced photodetector, operably coupled to the beam splitter, to generate a photocurrent representing an imaginary component of a product of the input and the weight.

17. The optical neural network of claim 16, wherein the first integrator comprises a capacitance coupled to an output of the balanced photodetector.

18. The optical neural network of claim 15, further comprising:
an analog-to-digital converter (ADC), operably coupled to an output of the first integrator, to generate a digital representation of an output of the QAM demodulator; and
a digital processor, operably coupled to the ADC, to apply a nonlinearity to the digital representation.
